(19) United States
(12) Patent Application Publication
(10) Pub. No.: US 2005/0212450 A1
(43) Pub. Date: Sep. 29, 2005

(54) Method and system for detecting electrical arcing in a plasma process powered by an AC source

(75) Inventors: Francisco Martinez, Dublin (IE); Paul Scullin, Dublin (IE); Justin Lawler, Dublin (IE); John Scanlan, Dublin (IE)

Correspondence Address: JOHN S. PRATT, ESQ;KILPATRICK STOCKTON, LLP, 1100 PEACHTREE STREET, ATLANTA, GA, 30309, US

(73) Assignee: Scientific Systems Research Limited

(21) Appl. No.: 11/048,083

(22) Filed: Feb. 1, 2005

(30) Foreign Application Priority Data
Mar. 16, 2004 (IE) 2004/0164

(51) Int. Cl. G09G 3/10

(52) U.S. Cl. 315/169.4; 315/169.1

(57) ABSTRACT

A method for detecting electrical arcing in a plasma process powered by an AC source comprises the steps of sampling at least one Fourier component of the AC source waveform distorted by the non-linear response of the plasma, determining when a change in amplitude of the component, irrespective of the direction of the change, exceeds any one of a plurality of different threshold levels, and determining the duration that each such threshold is exceeded. Each threshold is a predetermined fraction of a running average of the amplitude of the component.

### BACKGROUND OF THE INVENTION

1. Field of the Invention

The present invention relates to a method and system for detecting electrical arcing in a plasma process powered by an AC source.

2. Prior Art

Plasma processing of materials is used in a large number of industrial applications, which include the manufacturing of semiconductor devices, flat panel displays, optical components, magnetic storage devices and many more. These plasma processes include the deposition and etching of dielectrics, conductors and semiconductors on a substrate, for example, a silicon wafer. The plasma process usually involves placing the substrate in a vacuum chamber, introducing process gases and applying electrical power to create the plasma. The plasma can be powered by direct current power (DC) or by alternating current power (AC). For certain applications, AC powered plasmas are normally employed, with advantages over DC that include ability to use a dielectric substrate as an electrode, low pressure operation and power efficiency. Usually, in the set of AC powered plasma configurations, radio-frequency (RF) power, typically 100 kHz to 300 MHz, is preferred.

FIG. 1 shows a typical plasma process reactor. It includes a plasma chamber 1 containing a wafer or substrate 2 to be processed. A plasma is established and maintained within the chamber by an AC power source 3. This source generally has real impedance which must undergo a transformation to match that of the complex plasma load. This is done via match network 4. Power is coupled to the plasma chamber, typically by capacitive or inductive coupling, through an electrode 8. Process gases are admitted through gas inlet 7 and the chamber is maintained at a desirable pressure by pumping through gas exhaust line 10. A throttle valve 9 may be used to control pressure. Application of AC power then causes ignition of the plasma, which now consists of ions, electrons, radical gas species and neutral gas, all of which permit the desired reaction to proceed. FIG. 1 is used as an example only and shows a plasma processing configuration termed a capacitively coupled plasma. There are many other configuration types, including inductively coupled sources, magnetically enhanced configurations, and the plasma sources can be driven by single, multiple or mixed frequency RF generators.

The match network can have several different configurations depending on the plasma impedance, but generally contains inductive, capacitive and resistive elements. These components are chosen to optimise power transfer from the resistive generator output impedance to the complex plasma impedance. Very often the match network can be tuned to optimise power delivery as the plasma impedance varies. Tuning can be done by either changing the inductive and/or capacitive elements and/or by changing the centre frequency of the generator.

The plasma represents a non-linear complex load in electrical terms. This results in distortion of the fundamental AC driving signal. FIG. 2 shows a typical AC power driving signal from the generator, measured in region A of FIG. 1, referred to hereafter as the “pre-match region”. The waveform is generally a relatively pure sinusoidal with a single fundamental frequency, which is the generator centre frequency. FIG. 3 shows a typical waveform now measured in region B of FIG. 1, referred to hereafter as the “post-match region”. The waveform no longer comprises mainly a single frequency, but is distorted to includes a number of harmonics of the fundamental frequency. These harmonics are generated by the non-linear response of the plasma to the AC power applied. The relative amplitude of each of the harmonic components depends on the overall plasma impedance and will change as plasma inputs (such as pressure, gas flows, power, and so on) change.

An RF sensor 5, FIG. 1, such as described in U.S. Pat. No. 6,501,285, can be used to sample the complex RF waveform in the post-match region. This sensor is located along the transmission line in region B. A processing unit 6 in FIG. 1, such as described in U.S. Pat. Nos. 6,061,006 and 6,469,488, is used to extract the Fourier components from the waveform.

In normal operating conditions the plasma fills the desired volume of the chamber and the process proceeds via the physical and chemical processes enabled by the plasma. For example, in an etching application, chemical gases are dissociated, ionized and etch the substrate as required. A frequent fault condition in any plasma chamber is an electrical arc. Arcs can have various configurations but generally speaking a portion of the plasma power is redirected to a new path with a different (usually lower) impedance, and collapses into a localized region and into a very small volume. Arcs can occur from plasma to substrate, across regions of the substrate or across regions of the plasma chamber. Power is dissipated in a small volume very rapidly, resulting in potential damage to the plasma chamber and an altered plasma process. The outcome can vary from increased contamination from the plasma chamber to catastrophic damage of the substrate.

Several methods for detection of arcing conditions have been proposed. U.S. Pat. No. 4,193,070 describes a method for DC plasma arc detection based on detecting a drop in voltage and an increase in current, indicative of some arc events. U.S. Pat. Nos. 4,694,402 and 5,561,605 describe methods for detecting arcs on an AC line by sampling the waveform and detecting a change in the AC waveform associated with the arc condition. U.S. Pat. No. 5,611,899 describes a similar technique applied to an AC sputtering process tool.

Arc events occurring on an AC powered plasma are difficult to detect because they can occur over very short times-scales and the arc event is normally only measurable in the post-match region. This is because the match unit has the characteristics of an electrical filter so that rapid changes in waveform, apparent in region B in FIG. 1, are not usually measurable in region A. Also, any change in plasma impedance, which is determined by the multitude of plasma inputs and the chamber itself, will change the measured waveform. Therefore, distinguishing an arc event from some other innocuous event, such as a change in plasma impedance, is difficult.

As stated above, an arc event is a collapse in local impedance as the plasma volume contracts. The referenced prior art operates by monitoring this collapse in the measured waveform. However, an arc event on an AC plasma does not necessarily lead to an impedance collapse at the measurement point. This is because the impedance measurement is located within the transmission line of the post match region.

FIG. 4 shows a Smith Chart plot of the impedance along the transmission line of region B in FIG. 1. The impedance measured along the transmission line changes according to position on the transmission line (shown as the dashed circle on the Smith chart in FIG. 4), as is well known by those skilled in the art of radio-frequency electrical engineering. The plasma impedance is represented by the point P1 in FIG. 4. The RF sensor measures an impedance at a point P2 in FIG. 4. When an arc occurs in the plasma, its impedance collapses, indicated by the arrow in FIG. 4. Note, however, how the impedance measured by the sensor increases in this example.

A further problem with the prior art is that many plasma systems use mixed and/or dual frequency RF power generators. The plasma driving signal can therefore be modulated by another different frequency. To measure an arc in such a configuration it is not sufficient to monitor a collapse in waveform since the modulation would lead to a false trigger for an arc condition.

It is the object of this invention, therefore, to provide an improved method and system for detecting electrical arcing in a plasma process powered by an AC, and especially an RF, source.

### SUMMARY OF THE INVENTION

According to the present invention there is provided a method for detecting electrical arcing in a plasma process powered by an AC source, comprising the steps of:
(a) sampling at least one Fourier component of the AC source waveform distorted by the non-linear response of the plasma,
(b) determining when a change in amplitude of the component(s), irrespective of the direction of the change, exceeds at least one threshold level, and
(c) determining the duration that the said threshold is exceeded.

Preferably, step (b) determines when the change in amplitude exceeds any one of a plurality of different threshold levels, and step (c) determines the duration that each such threshold is exceeded.

Preferably, too, the or each threshold is a predetermined fraction of a running average of the amplitude of the component.

In the preferred embodiment the method further includes recording cumulative data representing the number of changes and their durations, as determined in steps (b) and (c), over a predetermined period of the process.

The invention further provides a system adapted to perform the above method.

The embodiment is based on the assumption that an arc on an AC plasma chamber has a particular “signature”. This signature is a change in the Fourier components of the waveform, characterised by a magnitude and time period. Arc events are classified according to these parameters.

### BRIEF DESCRIPTION OF THE DRAWINGS

An embodiment of the invention will now be described, by way of example, with reference to the accompanying drawings, in which:

FIG. 1 depicts a typical plasma process chamber;

FIG. 2 shows a typical RF waveform in the pre-match circuit;

FIG. 3 shows a typical RF waveform in the post-match circuit;

FIG. 4 shows a Smith chart plot of the impedance along the transmission line of region B in FIG. 1;

FIG. 5 shows changes in a post-match RF waveform caused by arcing;

FIG. 6 shows two different arc signatures derived using the principles described herein;

FIG. 7 is a flow diagram of steps of the embodiment; and

FIG. 8 shows arc count determined by the embodiment as a function of time coincident with particle count on a substrate.

### DETAILED DESCRIPTION OF A PREFERRED EMBODIMENT

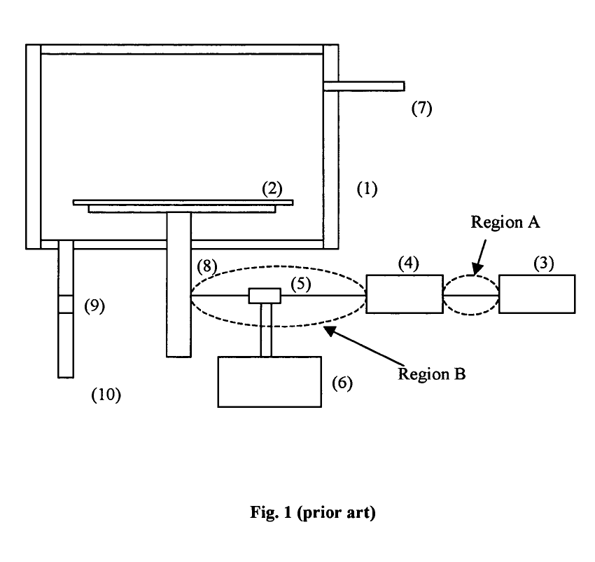

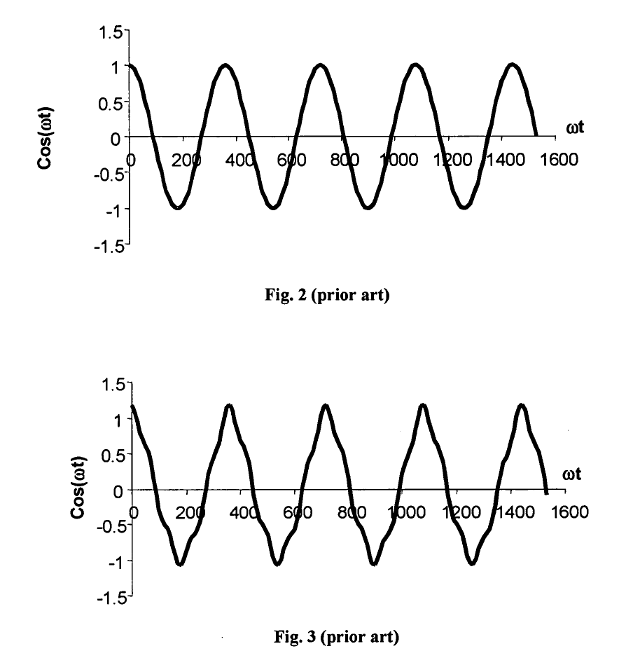

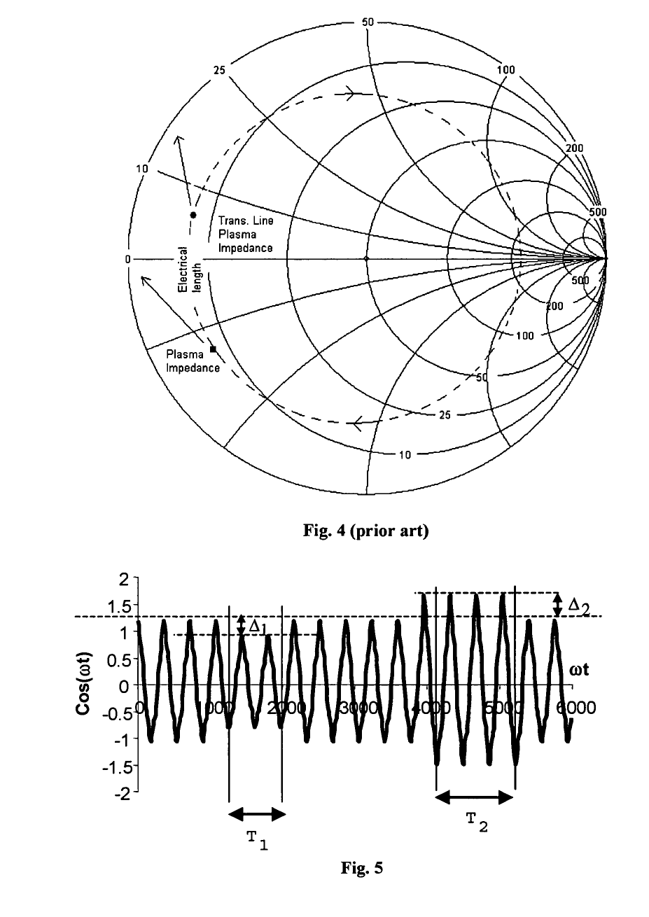

FIG. 5 shows a waveform sampled from the post-match region of an AC plasma process tool using the RF sensor 5, FIG. 1. In two particular regions a plasma arc occurs, causing a change in the amplitude of the waveform for a particular length of time. The first arc is characterised by a drop Δ₁ in the waveform amplitude for a time of T₁, while the second arc is characterised by an increase Δ₂ in the waveform amplitude for a time of T₂ (the changes Δ₁ and Δ₂ are substantially instantaneous compared to the period of the waveform). The method for detecting such arcs, described herein, is based on detecting such waveform amplitude changes, irrespective of their direction (i.e. whether the change is an increase or decrease in the amplitude), and characterising electrical arcs based on the magnitude of the change and the time for which the change occurs.

In the embodiment to be described, the first Fourier component, or fundamental, of the sampled voltage or current is used to detect and classify different arc conditions. Arc events can originate in different regions, as described above, depending on plasma and chamber conditions. Arcs between high voltage regions and ground can be very destructive and are characterised by a near collapse in voltage and a corresponding large rise in current between the common high voltage regions and ground. They generally survive over many AC cycles. Arcs across a surface that is designed to have a single potential, such as across the substrate or a chamber component exposed to plasma, are generally much shorter lived and less destructive. For example, micro-arcs originating from small regions of differing potential on a chamber component exposed to plasma are often caused by growth of a contaminant at a particular point. Local charging drives the arc, so that the arc terminates as the contaminant is removed, often by the arc itself. Similarly, part wear or configuration changes can drive micro-arcs if local charging builds up on surfaces designed to carry a single potential.

In the embodiment, an arc is characterised by two sets of parameters. Firstly, Δ, shown in FIG. 5, is a measure of the magnitude of the change in amplitude relative to a moving average of the amplitude of the sampled voltage or current. The moving average is typically taken over the previous 10000 cycles of the waveform. The change Δ is compared to a set of threshold values, for example 6%, 12%, 25%, 50% of the moving average. Secondly, T, also shown in FIG. 5, is the number of cycles for which the change Δ exceeds a given threshold level. Classification bins are assigned to identify the temporal length of the arc event, i.e. the number of waveform cycles for which the change A exceeded the relevant threshold. For example, in the present embodiment, for any given threshold, a change persisting for 1-15 waveform cycles is assigned to bin 1 (i.e. the bin count is incremented by one), a change persisting for 15-255 cycles is assigned to bin 2, a change persisting for 256-4095 cycles is assigned to bin 3 and a change persisting for greater than 4096 cycles is assigned to bin 4. It is to be noted that any given change is only assigned to one bin, that corresponding to the highest threshold level which it exceeds. By this means any arc event can be classified according to the size of the waveform change relative to a moving average and the number of waveform cycles over which the change occurs. In such a classification system, a micro arc would appear over few cycles and may exceed the lowest threshold only. More damaging arcs would more long lived and may breach the highest threshold.

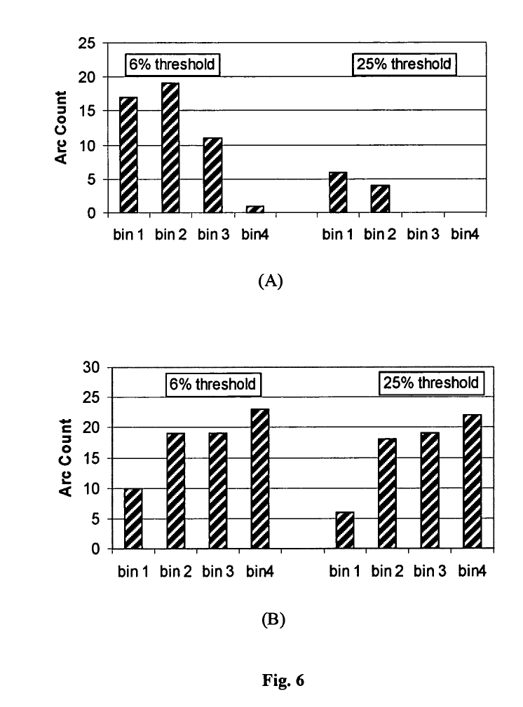

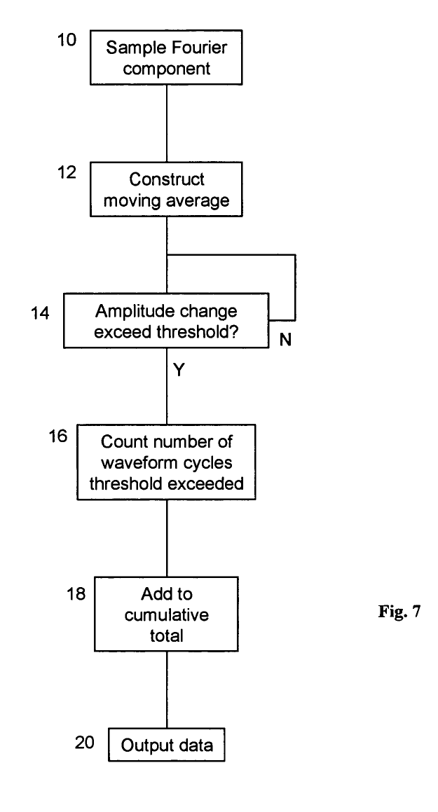

While it would be possible to use the invention to identify and classify individual arc events, the more practical application, used in the present embodiment, is to accumulate data over a period of time to generate a “signature” of the process. For example, the data might be accumulated over all or part of a plasma process on a semiconductor substrate. FIG. 6 shows typical signatures from two processes showing different arcing conditions during the process (the classification bins for only the 6% and 25% thresholds are shown). Signature A shows that most arcing occurred at the lowest threshold, indicative primarily of micro-arcs, while signature B indicates the presence of more long-lived and potentially damaging arcs were occurring during the relevant period. It is therefore possible to separate and classify these different arc phenomena using the method described. The advantage of classifying arcs in this way is that other changes in the waveform, which could result from an impedance change caused by a shift in process conditions, can be separated from arc events.

FIG. 7 is a flow diagram of the embodiment, which is implemented in software in the processing unit 6.

During the plasma process the waveform of the selected Fourier component, in this case the fundamental, is extracted and sampled, step 10, using the techniques described, for example, in U.S. Pat. Nos. 6,501,285, 6,061,006 and 6,469,488. At step 12 the moving average of the waveform amplitude over the previous 10000 cycles is constructed, as described above, and this is continuously updated. Step 14 monitors the instantaneous amplitude of the component for an amplitude change exceeding any of the thresholds, and if one of the thresholds is exceeded the number of cycles of the waveform which exceed the threshold is counted, step 16, and the count in the relevant bin for that threshold is incremented by one, step 18. Finally, at the end of the process, step 20, the accumulated data is output for evaluation by a human operator. This output may be in the form of bar charts similar to those shown in FIG. 6, which can be displayed on a display screen, or the data may be printed out in any suitable fashion for interpretation by the operator.

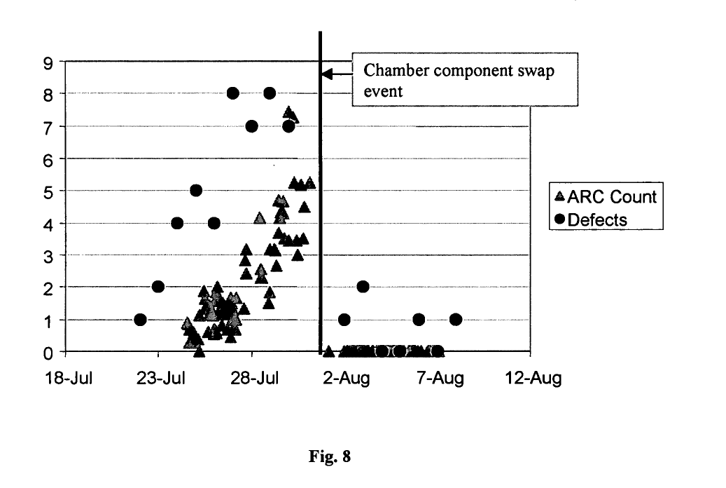

FIG. 8 shows how the embodiment may be used in a production environment, in this case a plasma etch chamber used to produce a semiconductor device. On a daily basis, at least one test wafer is used to measure particles deposited on the wafer during the process by ex-situ particle measurement. The arc count (from bin 4 at 25% in this example) is shown over a period of time concurrently with particle count from the said ex-situ particle measurement. As a particular chamber part wears, micro-arcs begin to occur on the tool part, as manifested by the arc “signature”, and increased particle levels are seen on the wafers. A scheduled maintenance event replaces the chamber part and particle levels drop. As can be seen, the arc count is well correlated with the ex-situ particle measurement. It will be understood that although the example in FIG. 8 only uses bin 4 at 25%, that is only because the operator knows by experience that for that particular process and that particular chamber part, that is the bin of interest. All the other data will still be available to him.

Having classified the arcing condition, the plasma tool operator is better informed to react. If the arc signature represents arcing that would destroy the entire substrate or damage a chamber part, the operator can stop further processing. If the arc signature represents arcing that occurs on the wall and does not impact substrate conditions then the operator can choose to ignore it. The operator can also schedule a maintenance event based on an arc count threshold for a particular arc signature.

The operator can also use the invention to optimise process recipe design. Certain recipes will be more prone to arcing than others, depending on plasma chamber configuration and process inputs (e.g. pressure, gas flow, power). By monitoring for specific arc types, the operator can choose the best operating conditions for a particular process.

This operator control can also be automated by a suitable control algorithm running on a computer or control electronics.

It is to be understood that a Fourier component other than the voltage or current at the fundamental frequency, as used in the above embodiment, can be employed in the invention. For example, a Fourier component at a harmonic of the fundamental could be used. Alternatively, a combination of Fourier components can be used. In such a case the amplitudes of the individual sampled components would be summed, and the sum compared to thresholds established relative to the running average of the sum. Furthermore, a complex Fourier component such as the phase angle between voltage and current at the fundamental frequency or a harmonic thereof could alternatively be used in the invention. In systems with more than one driving frequency, any one can be selected as is best suited for detecting arcs in the particular configuration concerned.

The invention is not limited to the embodiments described herein which may be modified or varied without departing from the scope of the invention.

1. A method for detecting electrical arcing in a plasma process powered by an AC source, comprising the steps of:
(a) sampling at least one Fourier component of the AC source waveform distorted by the non-linear response of the plasma,
(b) determining when a change in amplitude of the component(s), irrespective of the direction of the change, exceeds at least one threshold level, and
(c) determining the duration that the said threshold is exceeded.

2. The method claimed in claim 1, further including recording cumulative data representing the number of changes and their durations, as determined in steps (b) and (c), over a predetermined period of the process.

3. The method claimed in claim 2, further including outputting the cumulative data for evaluation by a human operator.

4. The method claimed in claim 1, wherein step (b) determines when the change in amplitude exceeds any one of a plurality of different threshold levels, and step (c) determines the duration that each such threshold is exceeded.

5. The method claimed in claim 1, wherein the or each threshold is a predetermined fraction of a running average of the amplitude of the component.

6. The method claimed in claim 1, wherein the Fourier component is the voltage or current at the fundamental frequency of the AC source or a harmonic thereof.

7. The method claimed in claim 1, wherein the Fourier component is the phase angle between voltage and current at the fundamental frequency or a harmonic thereof.

8. The method claimed claim 1, wherein in step (a) a plurality of Fourier components are sampled and in step (b) the amplitude is the sum of the amplitudes of the individual components.

9. The method claimed in claim 3, further comprising stopping the process according to the evaluation.

10. The method claimed in claim 3, further comprising altering the process recipe according to the evaluation.

11. The method claimed in claim 3, further comprising scheduling a maintenance event according to the evaluation.

12. A system for detecting electrical arcing in a plasma process powered by an AC source, comprising means for:
(a) sampling at least one Fourier component of the AC source waveform distorted by the non-linear response of the plasma,
(b) determining when a change in amplitude of the component(s), irrespective of the direction of the change, exceeds at least one threshold level, and
(c) determining the duration that the said threshold is exceeded.
